(19) United States
(12) Patent Application Publication
(10) Pub. No.: US 2026/0110492 A1
(43) Pub. Date: Apr. 23, 2026

(54) WET HEARTH MELTING SYSTEMS AND METHODS FOR MELTING SOLID METALS

(71) Applicant: The Schaefer Group, Inc., Dayton, OH (US)

(72) Inventor: David Andrew Robinson, Beavercreek, OH (US)

(73) Assignee: The Schaefer Group, Inc., Dayton, OH (US)

(21) Appl. No.: 19/361,291

(22) Filed: Oct. 17, 2025

Related U.S. Application Data
(60) Provisional application No. 63/710,713, filed on Oct. 23, 2024.

(51) Int. Cl. F27B 3/12; F27B 3/18; F27B 3/19; F27B 3/28

(52) U.S. Cl. CPC F27B 3/12; F27B 3/18; F27B 3/19; F27B 3/28; F27B 2003/125

(57) ABSTRACT

A system for melting metals includes a heating chamber configured to contain a molten metal, a wet hearth melting chamber, and a pump. The wet hearth melting chamber includes a wet hearth inlet, a wet hearth outlet, and a refractory shelf having a top surface. The refractory shelf has a plurality of rails disposed on top of the top surface and spaced apart from one another to form flow channels. The wet hearth melting chamber has an inlet channel fluidly coupling the wet hearth inlet to the top surface of the refractory shelf and an outlet channel fluidly coupling the top surface of the refractory shelf to the wet hearth outlet. The pump is in an inlet flow path between the heating chamber and the wet hearth melting chamber and is configured to pump molten metal from the heating chamber through the wet hearth melting chamber.

### CROSS-REFERENCE TO RELATED APPLICATION

This application claims the benefit of priority to U.S. Provisional Patent Application No. 63/710,713, filed on Oct. 23, 2024, and entitled “Wet Hearth Melting Systems and Methods for Melting Solid Metals,” the entire contents of which are incorporated by reference herein.

### BACKGROUND

### Field

The present specification generally relates to systems and methods for producing a volume of molten metal, in particular, to wet hearth systems and methods for heating and melting metals.

### Technical Background

Some metal forming operations, such as casting or liquid forging operations, for making a plurality of articles or parts require producing and maintaining a volume of molten metal to provide a supply of the molten metal to the metal forming operation. Conventional systems for melting metals include a melting chamber in which heating elements are used to heat and melt solid metal to form a molten metal, which is then transferred to a reservoir where the molten metal is maintained at a temperature above the melting temperature of the metal. Often, natural gas burners are used in conventional system to heat and melt the solid metal to form the molten metal. In other conventional systems, cold metal is added to and submerged in a volume of molten metal, such as a vortex of molten metal, to melt the solid metal.

### SUMMARY

According, there is an ongoing need for systems and methods for melting metals for metal forming processes. According to one or more aspects of the present disclosure, a system for melting metals includes a heating chamber configured to contain a molten metal, a wet hearth melting chamber, and a pump. The heating chamber may include a heating chamber inlet, a heating chamber outlet, and one or more heating elements configured to add heat to the molten metal contained within the heating chamber. The wet hearth melting chamber includes a wet hearth inlet in fluid communication with the heating chamber outlet through an inlet flow path, a wet hearth outlet in fluid communication with the heating chamber inlet through an outlet flow path, and a refractory shelf having a top surface positioned vertically above the wet hearth inlet and the wet hearth outlet. The refractory shelf has a plurality of rails disposed on top of the top surface. The plurality of rails may be spaced apart from one another to form a plurality of flow channels therebetween. The wet hearth melting chamber may define an inlet channel fluidly coupling the wet hearth inlet to the top surface of the refractory shelf and an outlet channel fluidly coupling the top surface of the refractory shelf to the wet hearth outlet. The pump may be disposed in the inlet flow path between the heating chamber outlet and the wet hearth inlet. The pump is configured to produce a flow of the molten metal from the heating chamber to the wet hearth melting chamber through the inlet flow path.

According to one or more other aspects disclosed herein, a method of melting a solid metal charge using the systems disclosed herein may include placing the solid metal charge on the plurality of rails in the wet hearth melting chamber, introducing an inert atmosphere into the wet hearth melting chamber, and generating a flow of the molten metal from the heating chamber to the wet hearth melting chamber. The molten metal may flows through the flow channels defined between the rails and heat may transfer from the molten metal to the solid metal charge supported on the rails. The methods may further include increasing the flow rate of the molten metal until the level of the molten metal in the wet hearth melting chamber increases and submerges at least a portion of the solid metal charge, where submersion of the at least a portion of the solid metal charge causes the solid metal charge to melt.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

The accompanying drawings are included to provide a further understanding of the various embodiments, and are incorporated into and constitute a part of this specification. The drawings are not to scale and certain features in the Figures may be exaggerated for purposes of illustration. The drawings illustrate the various embodiments described herein, and together with the description serve to explain the principles and operations of the claimed subject matter.

FIG. 1 schematically depicts a process flow diagram for a system for melting a solid metal, according to embodiments shown and described herein;

FIG. 2 schematically depicts a front perspective view of a system for melting a solid metal, according to embodiments shown and described herein;

FIG. 3 schematically depicts a top view of the system of FIG. 2, according to embodiments shown and described herein;

FIG. 4 schematically depicts a front cross-sectional view of the system of FIG. 2 taken along reference line A-A in FIG. 3, according to embodiments shown and described herein;

FIG. 5 schematically depicts a top cross-sectional view of the system of FIG. 2 taken along reference line B-B in FIG. 2, according to embodiments shown and described herein;

FIG. 6 schematically depicts a cross-sectional view of the system of FIG. 2 taken along reference line C-C in FIG. 5, according to embodiments shown and described herein; and

FIG. 7 schematically depicts a side cross-sectional view of the system of FIG. 2 taken along reference line M-M in FIG. 3, according to embodiments shown and described herein.

### DETAILED DESCRIPTION

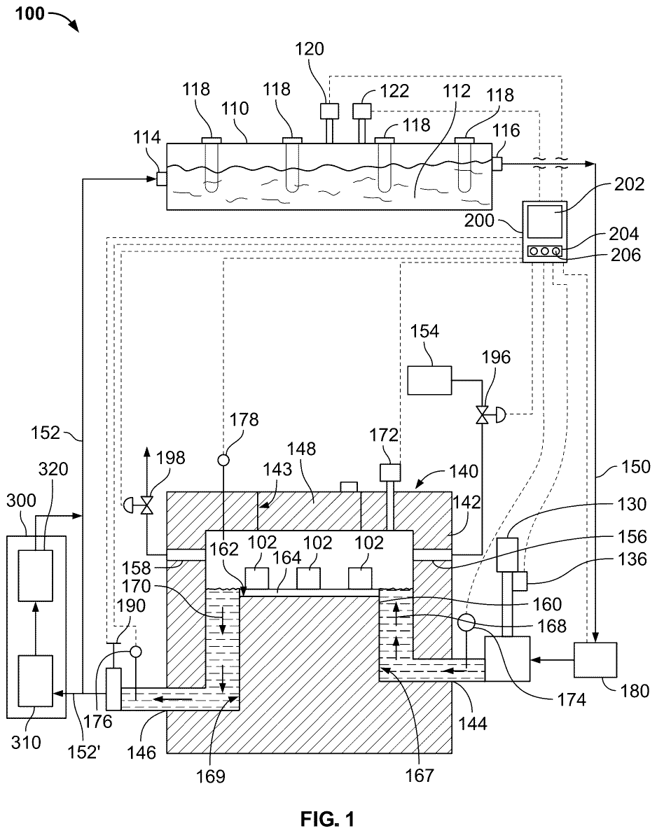

Reference will now be made in detail to embodiments of the present disclosure, examples of which are illustrated in the accompanying drawings. Whenever possible, the same reference numerals will be used throughout the drawings to refer to the same or like parts. Referring to FIG. 1, a process flow diagram for one embodiment of a system 100 disclosed herein for melting metals is schematically depicted. The system 100 comprises a heating chamber 110 configured to contain a molten metal 112, a pump 130, and a wet hearth melting chamber 140. The heating chamber 110 comprises a heating chamber inlet 114, a heating chamber outlet 116, and one or more heating elements 118 configured to add heat to the molten metal 112 contained within the heating chamber 110. The wet hearth melting chamber 140 comprises a wet hearth inlet 144 in fluid communication with the heating chamber outlet 116 through an inlet flow path 150 and a wet hearth outlet 146 in fluid communication with the heating chamber inlet 114 through an outlet flow path 152. The wet hearth melting chamber 140 may further include a refractory shelf 160 having a top surface 162 positioned vertically above the wet hearth inlet 144 and the wet hearth outlet 146. The wet hearth melting chamber 140 further includes a plurality of rails 164 disposed on the top surface 162 of the refractory shelf 160 and spaced apart from one another to form a plurality of flow channels 166 therebetween. The wet hearth melting chamber 140 may define an inlet channel 168 fluidly coupling the wet hearth inlet 144 to the top surface 162 of the refractory shelf 160 and an outlet channel 170 fluidly coupling the top surface 162 of the refractory shelf 160 to the wet hearth outlet 146. The pump 130 may be disposed in the inlet flow path 150 between the heating chamber outlet 116 and the wet hearth inlet 144. The pump 130 may be configured to produce a flow of the molten metal 112 from the heating chamber 110 to the wet hearth melting chamber 140 through the inlet flow path 150.

During operation, the molten metal 112 flows through the flow channels 166 defined between the rails 164 and provides heat to a solid metal charge 102 loaded into the wet hearth melting chamber 140 and supported on the rails 164. In a heating mode, the molten metal 112 provides heat to the solid metal charge 102 through convection and radiation heat transfer mechanisms. In a melting mode, the level of the molten metal 112 in the wet hearth melting chamber 140 is increased to submerge at least a portion of the solid metal charge 102 in the molten metal 112, which introduces heat transfer by conduction. Contact of the molten metal 112 with at least a portion of the solid metal charge 102 may cause the portion of the solid metal charge 102 to melt.

The system 100 may be used in methods of melting metals. The methods may include placing a solid metal charge 102 on the rails 164 in the wet hearth melting chamber 140, introducing an inert atmosphere into the wet hearth melting chamber 140, and generating a flow of a molten metal 112 from the heating chamber 110 to the wet hearth melting chamber 140. The molten metal 112 may flow through the flow channels 166 defined between the rails 164 and heat may transfer from the molten metal 112 to the solid metal charge 102 supported on the rails 164. The methods may further include increasing a flow rate of the molten metal 112 until a level of the molten metal 112 in the wet hearth melting chamber 140 increases and the molten metal 112 submerges at least a portion of the solid metal charge 102, where submersion of the at least a portion of the solid metal charge 102 causes that portion to melt.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein—for example up, down, right, left, front, back, top, bottom—are made only with reference to the figures as drawn and the coordinate axis provided therewith and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “wet hearth” refers to a chamber for melting a solid metal through contact with a molten metal.

As used herein, the terms “upstream” and “downstream” refer to the relative positioning of features of the system with respect to the direction of flow of the molten metal. A first feature of the system is considered “upstream” of a second feature if the molten metal flowing through the system encounters the first feature before encountering the second feature. Likewise, a first feature is considered “downstream” of the second feature if the molten metal flowing through the system encounters the second feature before encountering the first feature. Since the system 100 disclosed herein for melting metal comprises a recirculating loop of molten metal, the terms “upstream” and “downstream” are used herein relative to the heating chamber 110, meaning that the heating chamber outlet 116 is the farthest upstream point, the heating chamber inlet 114 is the farthest downstream point, and the fluid flow of the molten metal 112 through the system 100 is generally from the heating chamber outlet 116 towards the heating chamber inlet 114.

Some common metals used in molding or casting operations, such metals including but not limited to aluminum, magnesium, or alloys thereof, absorb hydrogen and water (H₂O) from the atmosphere. The presence of hydrogen and water in the solid aluminum or magnesium metal can cause rapid expulsion of these gases when the solid metal is added to a molten metal. Additionally, the use of fossil fuel burners to melt metal in conventional systems can increase impurities in the molten metal. These impurities can manifest in the molten metal in the form of dross or carbon-based impurities (formation of carbides). The presence of oxygen in the melting chamber can also cause oxidation of the aluminum and/or magnesium, further increasing the formation of impurities and reducing the yield of usable molten metal produced from the solid metal charge.

Accordingly, an ongoing need exists for systems for melting metals in a controlled environment to reduce the risk of rapid gas expulsion and formation of impurities. The present disclosure is directed to a system for melting solid metals in a controlled environment to produce a volume of molten metal, such as aluminum, magnesium, alloys of aluminum, alloys of magnesium, other metals, or combinations thereof. The systems disclosed herein include a heating chamber, a pump, and a wet hearth melting chamber. The heating chamber includes a plurality of heating elements and is configured to maintain the volume of molten metal in a molten state. The pump is configured to pump the molten metal from the heating chamber to the wet hearth melting chamber. The wet hearth melting chamber may include a refractory shelf having a top surface and a plurality of rails on the top surface of the refractory shelf.

During operation of the system, the solid metal charge is placed on the rails on the top surface of the refractory shelf. After charging, inert gases are introduced to the wet hearth melting chamber to remove any oxygen, carbon oxides, hydrogen, water vapor, and other gases that react with the solid metal charge. Once the inert atmosphere is in place, the molten metal pump is operated to pump molten metal from the heating chamber to the wet hearth melting chamber. The molten metal flows through an inlet channel to the top surface of the refractory shelf. At the top surface of the refractory shelf, the molten metal flows through flow channels defined between the rails to an outlet channel on the opposite side of the wet hearth melting chamber, then from the outlet channel back to the heating chamber. When flowing through the flow channels defined between the rails, the molten metal comes into close proximity to or into contact with the bottom of the solid metal charge supported on the rails. The contact or close proximity of the molten metal to the bottom of the solid metal charge heats the solid metal charge and, in the case of contact with the bottom of the solid metal charge, begins to melt the solid metal charge. The newly melted metal combines with the flow of molten metal between the rails and passes to the outlet channel and back to the heating chamber.

The partial submersion of the solid metal charge in the molten metal allows any hydrogen, water, or other gases adsorbed into the metal, to desorb and evaporate from the metal, thereby reducing the risk of rapid and uncontrollable expulsion of the gases caused by complete submersion of the solid metal in the molten metal. These rapid gas expulsion events are generally contained within the melting chamber, but can damage equipment and produce waste. Thus, reducing the occurrence of these rapid gas expulsions can reduce or prevent damage to the equipment and reduce waste resulting therefrom. Partial submersion of the solid metal charge in the molten metal may also reduce or eliminate the need to preheat the solid metal charge before melting, which can save energy.

The level of the molten metal in the wet hearth melting chamber can also be increased or decreased through changing the speed of the pump to increase or decrease the amount of the solid metal charge submerged in the molten metal, thereby changing the melting rate of the solid metal charge. Thus, the level of the molten metal can be controlled to melt only so much metal as is needed to maintain the volume of molten metal in the heating chamber without overflowing the heating chamber. In other words, the rate of melting can be controlled to maintain a set volume of molten metal in the heating chamber. With this capability, several hours-worth of solid metal charge can be added at one time without risking overflow of the system.

Additionally, the melting is accomplished through contact with molten metal in the inert environment, which reduces exposure of the solid and molten metal to oxygen, hydrogen, moisture, or carbon-containing gases. Thus, the systems disclosed herein can reduce formation of impurities such as oxides, carbides, dross, and the like, can increase the yield of molten metal from the solid metal charge, and can reduce waste. The systems and methods disclosed here may also reduce the cleaning requirements, such as cleaning frequency, and may reduce downtime from cleaning. The systems and methods disclosed herein may increase life of the furnace and increase total productive time over the life of the furnace. The systems and methods disclosed herein may also allow for the heating and melting of prime solid metal charge materials, such as but not limited to sow, ingots, T-bar or other prime sources of solid metal charge, among other features.

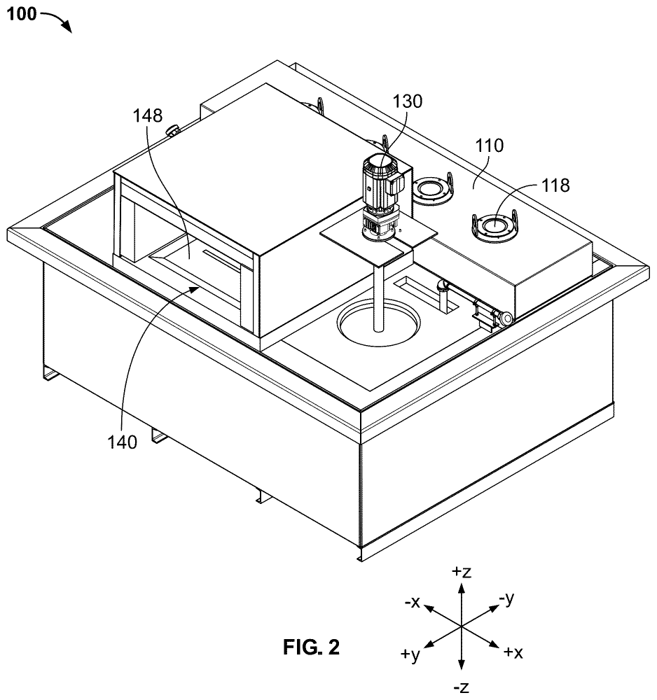

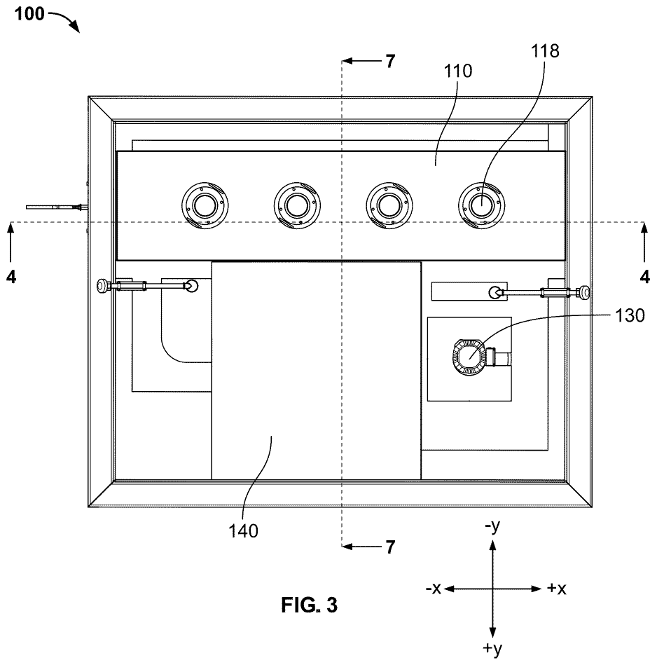

Referring now to FIG. 1, the systems 100 disclosed herein comprise the heating chamber 110, the pump 130 disposed downstream of the heating chamber 110, and the wet hearth melting chamber 140 disposed downstream of the pump 130. Referring to FIGS. 2 and 3, a perspective view and top view of an embodiment of the system 100 is schematically depicted showing the relative positions of the heating chamber 110, the pump 130, and the wet hearth melting chamber 140. Referring again to FIG. 1, the heating chamber 110 is configured to contain the molten metal 112. The heating chamber 110 may be constructed of a refractory material capable of withstanding temperatures at and above the melting temperature of the metal to be melted and the molten metal temperature required by the downstream metal forming process. The heating chamber 110 may have a volume sized according to the downstream metal forming process and the requirements thereof. The volume of the heating chamber 110 is not particularly limited.

Referring again to FIG. 1, the heating chamber 110 includes a heating chamber inlet 114, a heating chamber outlet 116, and one or more heating elements 118 configured to add heat to the molten metal 112 contained within the heating chamber 110. The heating chamber 110 may also include a process supply outlet (not shown) configured to supply the molten metal to the downstream metal forming process. The process supply outlet may be different from the heating chamber outlet 116. The heating chamber outlet 116 may be configured to allow molten metal 112 to flow out of the heating chamber 110 to the pump 130 downstream of the heating chamber 110. The heating chamber inlet 114 may be configured to return molten metal 112 to the heating chamber 110 from the wet hearth melting chamber 140. The heating chamber inlet 114 may be on an opposite side of the heating chamber 110 from the heating chamber outlet 116. This allows the returning molten metal, which is at a lower temperature compared to the molten metal 112 in the heating chamber 110, to be heated back to the set point temperature in the heating chamber 110 before being passed back out of the heating chamber outlet 116.

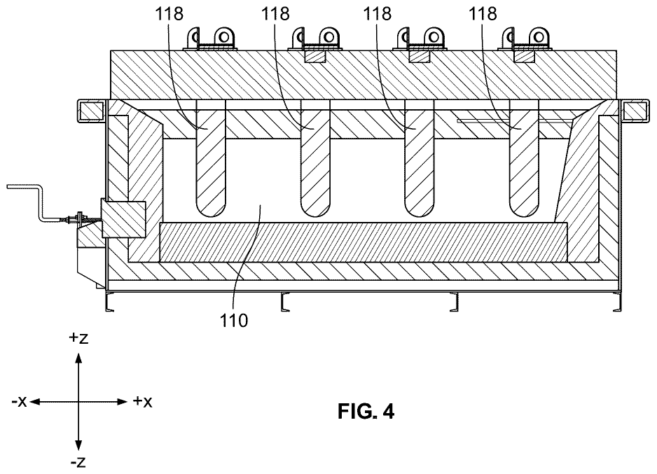

The heating chamber 110 may also be configured to heat the molten metal 112 to maintain the molten metal 112 in a molten state and at a set temperature, which depends on the requirements of the downstream metal forming process. Referring to FIG. 4, the heating chamber 110 may include a plurality of heating elements 118, which may be spaced apart along a length of the heating chamber 110. The heating elements 118 may comprise electric heating elements, gas fired burners, or any combinations thereof. In embodiments, the heating elements may be reverberatory heating elements, immersion heating elements, or any combination thereof. In embodiments, the heating elements 118 may be electric immersion heating elements.

Referring again to FIG. 1, the heating chamber 110 may include at least one heating chamber temperature sensor 120, which may be configured to measure a temperature of the molten metal 112 contained within the heating chamber 110. The heating chamber temperature sensor 120 may be any commercially-available temperature sensor capable of withstanding the temperatures and conditions in the heating chamber 110 and accurately measuring the temperature of the molten metal 112. The heating chamber 110 may further include a heating chamber level sensor 122 configured to measure a level of the molten metal 112 in the heating chamber 110. The heating chamber level sensor 122 may be a laser level sensor, a radar level sensor, a contact probe level sensor, an ultrasonic level sensor, other type of level sensor, or combinations of these. The output of the heating chamber level sensor 122 is indicative of the volume of the molten metal 112 in the heating chamber 110.

Referring again to FIGS. 1-3, the system 100 includes the pump 130, which may be disposed downstream of the heating chamber 110 and upstream of the wet hearth melting chamber 140. Referring to FIG. 1, the pump 130 may be disposed in an inlet flow path 150 between the heating chamber 110 and the wet hearth melting chamber 140. In embodiments, an inlet of the pump 130 may be in fluid communication with the heating chamber outlet 116 to pass molten metal 112 directly from the heating chamber 110 to the pump 130. An outlet of the pump 130 may be in fluid communication with the wet hearth inlet 144 to pass the molten metal 112 from the pump 130 to the wet hearth melting chamber 140. The pump 130 is configured to produce a flow of the molten metal 112 from the heating chamber 110 to the wet hearth melting chamber 140 through the inlet flow path 150.

The pump 130 may be any type of pump capable of pumping the molten metal 112. Examples of pumps suitable for the pump 130 may include but are not limited to an MMEI molten metal pump described in U.S. Patent Publication No. 2015/0224574A1; a Sanken-Sangyo displacement pump as described in U.S. Pat. No. 10,138,532B2; an overflow transfer style pump such as the KAMOGAWA™ pump available from Sanken-Sangyo; or any other pump suitable for pumping a molten metal. The pump 130 may be a variable speed pump capable of producing a range of molten metal flow rates at a given temperature. In embodiments, the pump 130 may include a pump speed controller 136 operatively coupled to the pump 130 and configured to change a pumping rate/speed of the pump 130.

Referring again to FIG. 1, the wet hearth melting chamber 140 may be disposed downstream of the pump 130. The wet hearth melting chamber 140 may include an outer wall 142, a top opening 143 in the outer wall 142, a wet hearth inlet 144, a wet hearth outlet 146, a loading hatch 148, a refractory shelf 160 having a top surface 162, and a plurality of rails 164 attached to the top surface 162 of the refractory shelf 160. The outer wall 142 may define the internal volume of the wet hearth melting chamber 140. The outer wall 142 may be made from a refractory material capable of withstanding the operating conditions and temperatures of the wet hearth melting chamber 140. The outer wall 142 may have the top opening 143 to enable the solid metal charge 102 to be loaded into the wet hearth melting chamber 140.

The wet hearth melting chamber 140 may further include a loading hatch 148 disposed over the opening 143 in the top of the outer wall 142. The loading hatch 148 may be moveable between an open position and a closed position. In embodiments, the loading hatch 148 may be attached to the outer wall 142 of the wet hearth melting chamber 140 by a hinge or other structure that enables the loading hatch 148 to pivot between the open position and the closed position. In the open position the loading hatch 148 exposes the top opening 143 to allow loading of the solid metal charge 102 into the wet hearth melting chamber 140. In the closed position, the loading hatch 148 seals against the outer wall 142 of the wet hearth melting chamber 140 to close off and seal the top opening 143. In embodiments, the loading hatch 148 may create a seal over the top opening 143 to reduce or prevent gases from escaping from the wet hearth melting chamber 140 through the top opening 143.

Referring again to FIG. 1, the wet hearth melting chamber 140 has the wet hearth inlet 144, which may be in fluid communication with the heating chamber outlet 116 and the pump 130 through the inlet flow path 150. During operation, molten metal 112 flows through the inlet flow path 150 from the heating chamber 110, through the pump 130, and to the wet hearth inlet 144. The wet hearth melting chamber 140 may further include the wet hearth outlet 146, which may be in fluid communication with the heating chamber inlet 114 through the outlet flow path 152. During operation, the molten metal 112 and any newly melted metal from the wet hearth melting chamber 140 flow through the outlet flow path 152 from the wet hearth outlet 146 to the heating chamber inlet 114 and back into the heating chamber 110. The wet hearth outlet 146 may be on an opposite side of the wet hearth melting chamber 140 from the wet hearth inlet 144.

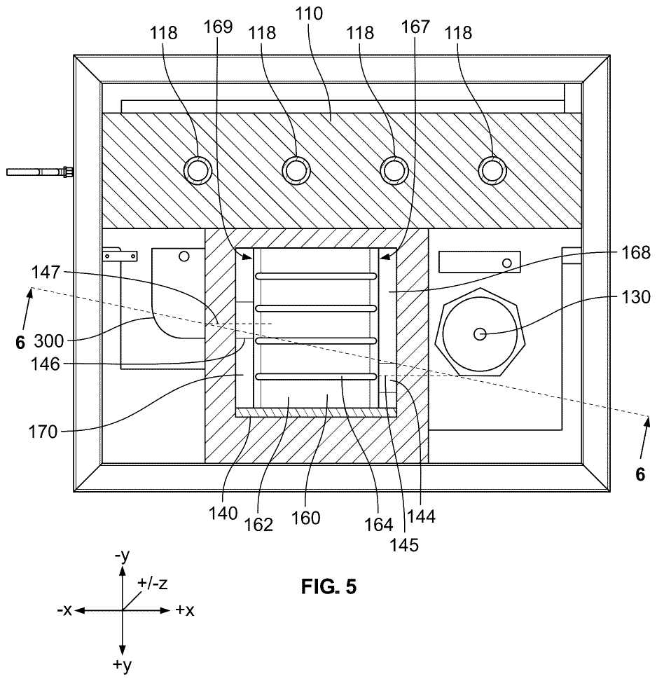

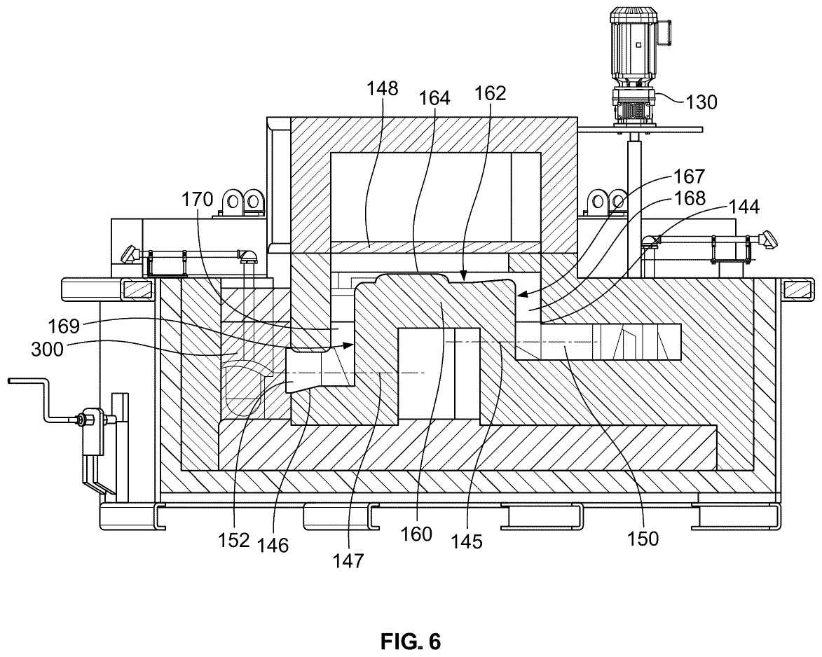

Referring now to FIGS. 5 and 6, the wet hearth outlet 146 may be offset from the wet hearth inlet 144 in a vertical direction (i.e., in the +/−Z direction of the coordinate axis in FIG. 6), a horizontal direction (i.e., a direction perpendicular to the Z axis of the coordinate axis in FIG. 6 or parallel to an X-Y plane of FIG. 5), or in the vertical and horizontal directions. Being offset in the vertical direction means that an outlet centerline 147 of the wet hearth outlet 146 is at an elevation (i.e., a +/−Z position of the coordinate axis in FIG. 6) that is different from an elevation of the inlet centerline 145 of the wet hearth inlet 144, as shown in FIG. 6. Referring to FIG. 6, the inlet centerline 145 of the wet hearth inlet 144 is a line in the X-Y plane of FIG. 6 that passes through the geometric center of the wet hearth inlet 144. The outlet centerline 147 of the wet hearth outlet 146 is a line in the X-Y plane of FIG. 6 that passes through the geometric center of the wet hearth outlet 146. Referring again to FIG. 5, being offset in the horizontal direction means that the outlet centerline 147 of the wet hearth outlet 146 is in a vertical plane that does not pass through the inlet centerline 145 of the wet hearth inlet 144. In embodiments, the wet hearth inlet 144 is not aligned with the wet hearth outlet 146 horizontally, vertically, or both. In embodiments, the inlet centerline 145 of the wet hearth inlet 144 and the outlet centerline 147 of the wet hearth outlet 146 are not congruent. In embodiments, the inlet centerline 145 of the wet hearth inlet 144 may be parallel to the outlet centerline 147 of the wet hearth outlet 146.

Referring to FIG. 6, the wet hearth inlet 144 may have a cross-sectional area that is different from a cross-sectional area of the wet hearth outlet 146. In embodiments, the wet hearth outlet 146 may have a cross-sectional area that is larger than the cross-sectional area of the wet hearth inlet 144. The wet hearth outlet 146 may have a cross-sectional area sized so that a volume flow rate of the molten metal 112 through the wet hearth outlet 146 is less than the sum of the maximum volume flow rate of the pump 130 plus the maximum melt rate when the molten metal 112 is at the maximum elevation in the wet hearth melting chamber 140 at maximum head pressure. The pump 130 and the wet hearth outlet 146 may be sized to provide a sufficient flow rate of the molten metal 112 to melt the solid metal charge 102 at a desired rate. In embodiments, the pump 130 and wet hearth outlet 146 may be sized to produce a ratio of a mass flow rate of the molten metal 112 to maximum melt rate of the solid metal charge 102 (in mass per hour) of 10:1. In other words, the maximum flow rate of the molten metal 112 through the wet hearth melting chamber 140 is at least 10 times the maximum desired melt rate of the solid metal charge 102 in the wet hearth melting chamber 140.

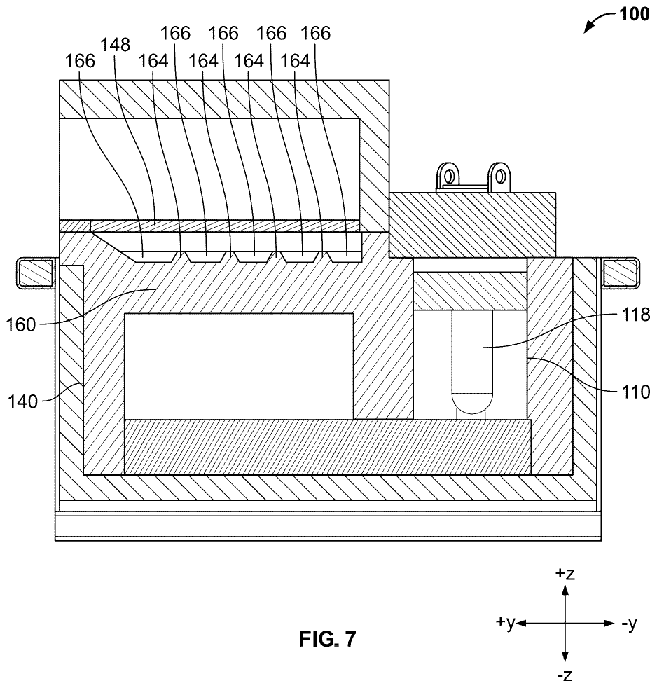

Referring again to FIG. 1, the wet hearth melting chamber 140 may include the refractory shelf 160, which may be disposed within the internal volume of the wet hearth melting chamber 140 between the wet hearth inlet 144 and the wet hearth outlet 146. The refractory shelf 160 has a top surface 162. Referring to FIG. 7, the top surface 162 may be a surface of the refractory shelf 160 facing upwards (i.e., facing in the +Z direction of the coordinate axis of FIG. 7) towards the top opening 143 of the wet hearth melting chamber 140. Referring again to FIG. 6, the top surface 162 of the refractory shelf 160 may be disposed vertically above the wet hearth inlet 144 and the wet hearth outlet 146. Referring again to FIGS. 1 and 5, the refractory shelf 160 may block the flow of the molten metal 112 directly from the wet hearth inlet 144 to the wet hearth outlet 146. Instead, the refractory shelf 160 forces the molten metal 112 to flow upwards through an inlet channel 168 to the top surface 162, across the top surface 162, and then down through an outlet channel 170 to the wet hearth outlet 146. As shown in FIG. 5, the refractory shelf 160 may attach to the outer wall 142 of the wet hearth melting chamber 140 on two opposing sides of the refractory shelf 160 to prevent the molten metal 112 from going around the refractory shelf 160.

Referring again to FIGS. 1, 5, and 6, the two opposing non-attached vertical sides of the refractory shelf 160 and the outer wall 142 of the wet hearth melting chamber 140 may define the inlet channel 168 and the outlet channel 170. In particular, an inlet vertical side 167 of the refractory shelf 160 may be spaced apart from the outer wall 142 of the wet hearth melting chamber 140 to define the inlet channel 168, which may extend from the wet hearth inlet 144 upward to at least the top surface 162 of the refractory shelf 160. The inlet channel 168 may fluidly couple the wet hearth inlet 144 to the top surface 162 of the refractory shelf 160 to allow the molten metal 112 to flow from the wet hearth inlet 144 to the top surface 162 of the refractory shelf 160 and over the refractory shelf 160 towards the outlet channel 170 and the wet hearth outlet 146. Likewise, an outlet vertical side 169 of the refractory shelf 160 may be spaced apart from the outer wall 142 of the wet hearth melting chamber 140 to define the outlet channel 170, which may extend from at least the top surface 162 of the refractory shelf 160 downward to the wet hearth outlet 146. The outlet channel 170 may fluidly couple the top surface 162 of the refractory shelf 160 to the wet hearth outlet 146 to allow the molten metal 112 to flow from the top surface 162 of the refractory shelf downward to the wet hearth outlet 146.

Referring again to FIGS. 1 and 5, the wet hearth melting chamber 140 further includes a plurality of rails 164 disposed on top of and attached to the top surface 162 of the refractory shelf 160. The rails 164 may be configured to support the solid metal charge 102 in the wet hearth melting chamber 140 while allowing molten metal 112 to flow across the top surface 162 of the refractory shelf 160 through flow channels 166 defined between the plurality of rails 164. Referring to FIG. 5, the rails 164 may be arranged with the long dimension extending between the inlet channel 168 and the outlet channel 170. In other words, the rails 164 may be aligned parallel to the +/−X direction of the coordinate axis in FIG. 5 so that they extend across the top surface 162 of the refractory shelf 160 from the inlet channel 168 to the outlet channel 170. Referring now to FIG. 7, the plurality of rails 164 are spaced apart from one another to define a plurality of flow channels 166 between the plurality of rails 164. The rails 164 may be spaced apart from one another in the +/−Y direction of FIG. 7 so that the flow channels 166 extend from the inlet channel 168 to the outlet channel 170. The flow channels 166 defined by the rails 164 may allow the molten metal 112 to flow across the top surface 162 of the refractory shelf 160 from the inlet channel 168 to the outlet channel 170.

The rails 164 may be constructed of a refractory material or a metal having a melting temperature considerably greater than the operating temperature of the molten metal 112. The rails 164 may have a height sufficient to allow the molten metal 112 to flow underneath the solid metal charge 102 supported by the rails 164 at a flow rate sufficient to heat and/or melt the solid metal charge 102. The height of the rails 164 refers to the vertical height (i.e., height in the +/−Z direction of the coordinate axis in FIG. 1) measured from the top surface 162 of the refractory shelf 160 to the topmost surface of the rails 164. If the height is too small, the cross-sectional area of the flow channels 166 may be too small, resulting in a flow rate of the molten metal 112 that is not sufficient to efficiently heat and/or melt the solid metal charge 102. The maximum height of the rails 164 may depend on the size and desired melting rate of the wet hearth melting chamber 140. In embodiments, the rails 164 may have a height of greater than or equal to 1 centimeter (cm), such as from 1 cm to 10 cm. In embodiments, the rails 164 may have a height greater than 10 cm.

Referring again to FIG. 1, during operation of the system 100, the pump 130 may be operated to pump the molten metal 112 from the heating chamber 110 to the wet hearth melting chamber 140. The molten metal 112 may enter the wet hearth melting chamber 140 through the wet hearth inlet 144 and flow through the inlet channel 168 to the top surface 162 of the refractory shelf 160. The molten metal 112 may then flow across the top surface 162 of the refractory shelf 160 through the flow channels 166 defined between the plurality of rails 164. At the outlet end of the top surface 162, the molten metal 112 may flow downward through the outlet channel 170 to the wet hearth outlet 146, and then back to the heating chamber 110 through the outlet flow path 152. In embodiments, the flow of the molten metal 112 through the outlet channel 170, wet hearth outlet 146, and outlet flow path 152 back to the heating chamber 110 may be accomplished through force of gravity. In embodiments, the flow of the molten metal 112 through the outlet channel 170 and outlet flow path 152 back to the heating chamber 110 may be accomplished through a difference in operating pressure between the wet hearth melting chamber 140 and the heating chamber 110. In embodiments, the wet hearth melting chamber 140 may be operated at a greater pressure, such as a greater gas pressure, compared to the heating chamber 110, which difference may be sufficient to move the molten metal 112 through the outlet flow path 152 back to the heating chamber 110. In embodiments, a combination of both gravity and pressure difference may affect flow of the molten metal 112 through the outlet flow path 152 from the wet hearth melting chamber 140 back to the heating chamber 110.

Referring again to FIG. 1, the wet hearth melting chamber 140 may comprise a wet hearth level sensor 172, which may be configured to measure a level of the molten metal 112 in the wet hearth melting chamber 140. The wet hearth level sensor 172 may be a laser level sensor, a radar level sensor, a contact probe level sensor, an ultrasonic level sensor, other type of level sensor, or combinations of these. The level is indicative of the flow rate of the molten metal 112 through the wet hearth melting chamber 140 at a given temperature. At a fixed temperature of the molten metal 112, the greater the flow rate of the molten metal 112 through the wet hearth melting chamber 140 the greater the level of the molten metal 112 in the wet hearth melting chamber 140. Thus, the level of the molten metal 112 in the wet hearth melting chamber 140 with respect to the solid metal charge 102, which is stationary, can be modified by increasing or decreasing the speed/pumping rate of the pump 130.

Referring again to FIG. 1, the wet hearth melting chamber 140 may further include an inlet temperature sensor 174 and an outlet temperature sensor 176. The inlet temperature sensor 174 may be disposed in the inlet flow path 150 between the heating chamber 110 and the wet hearth melting chamber 140. In embodiments, the inlet temperature sensor 174 may be disposed in the inlet flow path 150 between the pump 130 and the wet hearth melting chamber (i.e., downstream of the pump 130 and upstream of the wet hearth melting chamber 140). The inlet temperature sensor 174 may be configured to measure an inlet temperature of the molten metal 112 upstream of the wet hearth melting chamber. The outlet temperature sensor 176 may be disposed in the outlet flow path 152 between the wet hearth melting chamber 140 and the heating chamber 110, such as downstream of the wet hearth melting chamber 140 and upstream of the heating chamber 110. In embodiments, the outlet temperature sensor 176 may be disposed just downstream of the wet hearth outlet 146. The outlet temperature sensor 176 may be configured to measure an outlet temperature of the molten metal 112 downstream of the wet hearth melting chamber 140. The difference between the inlet temperature (as measured by the inlet temperature sensor 174) and the outlet temperature (as measured by the outlet temperature sensor 176) may provide an indication of progress during a preheating stage, an indication of melting rate of the solid metal charge 102 in the wet hearth melting chamber 140, or an indication of any other operating condition of the wet hearth melting chamber 140.

The wet hearth melting chamber 140 may also include an atmosphere temperature sensor 178 disposed in a headspace of the wet hearth melting chamber 140 between the top surface 162 of the refractory shelf 160 and the top opening 143 in the outer wall 142 of the wet hearth melting chamber 140. The atmosphere temperature sensor 178 may be configured to measure a temperature of the atmosphere inside the wet hearth melting chamber 140, such as a temperature of the inert atmosphere. The atmosphere temperature sensor 178 may be any commercially-available temperature sensor capable of measuring the temperature within the wet hearth melting chamber 140 and being able to withstand the temperatures and conditions inside the wet hearth melting chamber 140. The atmosphere temperature sensor 178 may be used to monitor the temperature inside wet hearth melting chamber 140 to make sure the temperature is hot enough to maintain the molten metal 112 in the molten state inside the wet hearth melting chamber 140 (e.g., hot enough to prevent the molten metal 112 from freezing) and to make sure the temperature is not so hot that the solid metal charge 102 melts uncontrollably.

Referring again to FIG. 1, the system 100 may include an inert gas source 154, and the wet hearth melting chamber 140 may further include a gas inlet 156 fluidly coupled to the inert gas source 154, and a gas outlet 158. The system 100 may further include a gas inlet control valve 196 disposed an inert gas supply line upstream of the gas inlet 156 and a gas outlet control valve 198 disposed in a gas discharge line downstream of the gas outlet 158. The inert gas source 154 may be a source of an inert gas selected from the group consisting of nitrogen, helium, neon, argon, krypton, xenon, and any combinations thereof. The gas inlet 156 of the wet hearth melting chamber 140 may be fluidly coupled to the inert gas source 154 and may be configured to introduce the inert gas from the inert gas source 154 into the wet hearth melting chamber 140. The gas inlet control valve 196 may be configured to control the flow of inert gas from the inert gas source 154 through the gas inlet 156 and into the wet hearth melting chamber 140. The gas outlet 158 may be configured to remove gases from the internal volume of the wet hearth melting chamber 140. The gas outlet control valve 198 may be configured to control the flow of gases out of the wet hearth melting chamber 140 through the gas outlet 158. In embodiments, the gas outlet 158 may be fluidly coupled to a vacuum source (not shown) that may be used to evacuate the atmosphere in the internal volume of the wet hearth melting chamber 140. The system 100 may be operable to evacuate the atmosphere in the wet hearth melting chamber 140 and then install an inert atmosphere in the wet hearth melting chamber 140 with inert gas from the inert gas source 154 after loading the solid metal charge 102 and before commencing preheating and/or melting in the wet hearth melting chamber 140.

Referring again to FIG. 1, in embodiments, the system 100 may include a supplemental heating unit 180 disposed in the inlet flow path 150 or in the outlet flow path 152. The supplemental heating unit 180 may be configured to provide further heat to the molten metal 112 upstream or downstream of the wet hearth melting chamber 140. In embodiments, the supplemental heating unit 180 may be disposed in the inlet flow path 150 upstream of the wet hearth melting chamber 140. The supplemental heating unit 180 in the inlet flow path 150 may be upstream or downstream of the pump 130. The supplemental heating unit 180 may include one or more heating elements. In embodiments, the heating elements of the supplemental heating unit 180 may include one or more electric heating elements, gas fired burners, or any combinations thereof. In embodiments, the heating elements of the supplemental heating unit 180 may comprise reverberatory heating elements, immersion heating elements, or any combination thereof. Supplemental heat may be added to the molten metal 112 by the supplemental heating unit 180 for purposes of changing the temperature of the molten metal 112 to change the viscosity and, therefore, the flow rate of the molten metal 112 through the system 100. Supplemental heat may also be added to the molten metal 112 to assist in maintaining the operating temperature of the molten metal 112 in the heating chamber 110, such as by replacing heat utilized to melt the solid metal charge 102.

Referring again to FIG. 1, in embodiments, the system 100 may include a gate valve 190 disposed in the outlet flow path 152 downstream of the wet hearth melting chamber 140. In embodiments, the gate valve 190 may be disposed proximate to the wet hearth outlet 146. The gate valve 190 may be configured to control the flow rate of the molten metal 112 flowing out of the wet hearth melting chamber 140 back to the heating chamber 110. Under certain conditions, such as increased temperature and viscosity of the molten metal 112, the wet hearth outlet 146 may be too large, resulting in the flow rate of the molten metal 112 out of the wet hearth melting chamber 140 being too great. This can make it difficult to maintain the level of the molten metal 112 in the wet hearth melting chamber 140 to maintain the desired melting rate of the solid metal charge 102. In these instances, the gate valve 190 may be used to restrict the flow through the outlet flow path 152, which may, in combination with pump speed, aid in maintaining the desired level of the molten metal 112 in the wet hearth melting chamber 140. The gate valve 190 may also be operated to allow the pumping rate of the pump 130 to be reduced while maintaining a constant level of the molten metal 112 in the wet hearth melting chamber 140. For instance, if the temperature of the wet hearth melting chamber 140 is too high, which risks uncontrollable melting of the solid metal charge 102, the pump speed of the pump 130 may be reduced to decrease the amount of heat introduced to the wet hearth melting chamber 140. At the same time the pump speed is decreases, the gate valve 190 may be operated to reduce the cross-sectional area of the wet hearth outlet 146, which works to reduce the outlet flow rate to maintain the level of the molten metal 112 in the wet hearth melting chamber 140 at the reduced pump speed.

Referring again to FIG. 1, operation of the system 100 to melt a solid metal charge 102 during continuous operation of the system 100 will now be discussed. The following discussion assumes a volume of molten metal 112 is already present in the heating chamber 110 in a molten state. Operation of the system 100 may include loading the solid metal charge 102 into the wet hearth melting chamber 140, sealing the wet hearth melting chamber 140, replacing the atmosphere in the wet hearth melting chamber 140 with an inert atmosphere comprising an inert gas, starting the flow of molten metal 112 to the wet hearth melting chamber 140 using the pump 130, and melting the solid metal charge 102. Operation of the system 100 may also include operating the wet hearth melting chamber 140 in a heating mode, such as maintaining the solid metal charge near the melting temperature when the heating chamber 110 is full or in an optional preheating step to preheat the solid metal charge 102.

Loading the solid metal charge 102 into the wet hearth melting chamber 140 may include opening the loading hatch 148 and placing the solid metal charge 102 on the rails 164 attached to the refractory shelf 160. The solid metal charge 102 may be any of the types of metals or forms of solid charge discussed herein, such as but not limited to aluminum, magnesium, alloys thereof, or any combinations thereof in the form of sow, ingots, T-bar, scrap, or any other type of solid form. After loading, the wet hearth melting chamber 140 may be sealed by closing the loading hatch 148 and sealing the loading hatch 148 against the outer wall 142 of the wet hearth melting chamber 140, such as by engaging a latch, locking mechanism, or other device to hold the loading hatch 148 in place against the outer wall 142.

Once the wet hearth melting chamber 140 is sealed, the atmosphere inside the wet hearth melting chamber 140 may be replaced with an inert atmosphere. Replacing the atmosphere inside the wet hearth melting chamber 140 may include removing the existing atmosphere, such as by evacuating the atmosphere from the gas outlet 158 using a vacuum system, followed by introducing an inert gas from the inert gas source 154, through the gas inlet 156, and into the wet hearth melting chamber 140. The gas inlet control valve 196 and the gas outlet control valve 198 may be manipulated or controlled to evacuate the existing atmosphere and introduce the inert atmosphere into the wet hearth melting chamber 140.

Once the wet hearth melting chamber 140 is loaded and the atmosphere replaced with an inert atmosphere, the pump 130 may be operated to produce a flow of the molten metal 112 from the heating chamber 110 to the wet hearth melting chamber 140. Operation of the pump 130 may cause the molten metal 112 to flow from the heating chamber 110, through the inlet flow path 150 to the wet hearth melting chamber 140. The molten metal 112 then flows through the wet hearth inlet 144, into the inlet channel 168, up through the inlet channel 168 to the top surface 162 of the refractory shelf 160, through the flow channels 166 defined between the rails, down through the outlet channel 170, through the wet hearth outlet 146, and through the outlet flow path 152 back to the heating chamber 110. As the molten metal 112 flows through the flow channels 166 between the rails 164, the molten metal heats the solid metal charge 102 that is supported by the rails 164. Depending on the operating mode, the heat transfer from the molten metal 112 to the solid metal charge 102 may be through radiation, convection, conduction, or combinations thereof.

The wet hearth melting chamber 140 may be operated in a melting mode in which the liquid level of the molten metal 112 in the wet hearth melting chamber 140 is increased using the pump 130, the gate valve 190, or a combination thereof, until the molten metal 112 contacts the bottom surface of the solid metal charge 102 and submerges at least a portion of the solid metal charge 102 within the molten metal 112. With a portion of the solid metal charge 102 submerged in the molten metal 112, heat transfers from the molten metal 112 to the solid metal charge 102 through conduction, convection, and radiation. The heat transfer is greatest through conduction, so contact of the solid metal charge 102 with the molten metal 112 may increase the temperature of the solid metal charge 102 to the melting point, causing at least a portion of the solid metal charge 102 to melt and join the flow of the molten metal 112 out of the wet hearth melting chamber 140. The heat transferred from the molten metal 112 to the bottom of the solid metal charge 102 may also cause hydrogen, water, or other impurities in the solid metal charge 102 to desorb from the surfaces not submerged in the molten metal 112. This enables the solid metal charge 102 to be heated and melted from the bottom without submerging the entirety of the solid metal charge 102 in the molten metal 112, which can lead to rapid expulsion of the impurity gases adsorbed into the metal. The rate of melting the solid metal charge 102 can be increased or decreased by increasing or decreasing, respectively, the level of the molten metal 112 in the wet hearth melting chamber 140 to submerge more or less of the solid metal charge 102. The level of the molten metal 112 can be increased and/or decreased by changing the speed of the pump 130 or by a combination of changing the speed of the pump 130 and manipulating the position of the gate valve 190.

In embodiments, the system 100 can be operated in a heating mode, such as when the heating chamber 110 is full and further melting would risk overflowing the heating chamber 110. The system 100 can also be operated in a heating mode if preheating of the solid metal charge 102 is desired. Preheating of the solid metal charge 102 can be accomplished but may not be necessary in all situations. The system 100 can be transitioned into heating mode by reducing the level of the molten metal 112 in the wet hearth melting chamber 140 to a level at which the molten metal 112 no longer contacts the bottom surface of the solid metal charge 102. In heating mode, the level of the molten metal 112 may be reduced below the bottom surface of the solid metal charge 102, such as below the top surface of the rails 164. The level can be reduced by reducing the pumping rate of the pump 130. In the heating mode, the pump 130 is still operated to flow the molten metal 112 through the flow channels 166 between the rails 164 without contacting the solid metal charge 102. In heating mode, the heat transfer from the molten metal 112 to the solid metal charge 102 is through primarily radiation, convection, or both.

Referring again to FIG. 1, in embodiments, the system 100 may further include an outlet well 300 disposed in the outlet flow path 152 between the gate valve 190 at the wet hearth outlet 146 and the heating chamber inlet 114. Referring now to FIGS. 6 and 7, the outlet well 300 may be disposed downstream of the wet hearth melting chamber 140 and upstream of the heating chamber 110. Referring again to FIG. 1, the outlet well 300 may include a filter unit 310, a degassing unit 320, or both. In embodiments, the system 100 may include the filter unit 310 in the outlet well 300. The filter unit 310 can be any filter device capable of filtering the molten metal 112 to remove impurities, such as but not limited to solid contaminants, oxide inclusions, and/or sludge/dross. The filter unit 310 may include a porous media operable to filter the impurities out of the molten metal 112. Examples of the filter unit 310 can include, but are not limited to, filter units disclosed in U.S. Pat. No. 7,157,043, granted Jan. 2, 2007, and entitled “Bonded Particle Filters.”

In embodiments, the system 100 may include the degassing unit 320 in the outlet well 300. The degassing unit 320 can be any device capable of removing entrained gases from the molten metal 112. The degassing unit 320 may be a rotary degasser, a lance wand, or combination thereof, which may be operable to bubble an inert gas through the molten metal 112 to remove the gases from the molten metal 112. In embodiments, the degassing unit 320 may be a rotary degasser, such as but not limited to the rotary degassers disclosed in U.S. Pat. No. 9,506,129, granted on Nov. 29, 2016, and entitled “Rotary Degasser and Rotor Therefor;” U.S. Pat. No. 5,678,807, granted on Oct. 21, 1997, and entitled “Rotary Degasser;” and Japanese Patent Application Publication No. JP-H07-233425, published Sep. 9, 1995, and entitled “Rotary Degassing Device.” Other types of degassing units 320 are contemplated.

Referring again to FIG. 1, the system 100 may include a control system 200 comprising at least one processor 202, at least one memory module 204 communicatively coupled to the processor(s) 202, and machine readable and executable instructions 206 stored on the at least one memory module 204. The control system 200 may be communicatively coupled to the heating elements 118 in the heating chamber 110, the heating chamber temperature sensor 120, the heating chamber level sensor 122, the pump speed controller 136, the wet hearth level sensor 172, the inlet temperature sensor 174 upstream of the wet hearth melting chamber 140, the outlet temperature sensor 176 downstream of the wet hearth melting chamber 140, the atmosphere temperature sensor 178 in the wet hearth melting chamber 140, the supplemental heating unit 180, the gate valve 190, the gas inlet control valve 196, the gas outlet control valve 198, or any combinations thereof, and may be configured to send and/or receive analog or digital data and/or control signals from each of these devices. In embodiments, the control system 200 may include a user input device for receiving input from a user, such input including but not limited to instructions to replace the atmosphere in the wet hearth melting chamber 140 with the inert atmosphere, operating the wet hearth melting chamber 140 in a heating mode or a melting mode, stopping operation of the wet hearth melting chamber 140, desired melting rate in the wet hearth melting chamber 140, or other instructions. The machine readable and executable instructions 206, when executed by the processor(s) 202, may cause the control system 200 to automatically execute any of the methods or method steps disclosed herein.

In embodiments, the machine readable and executable instructions 206, when executed by the processor(s) 202, may cause the control system 200 to automatically replace the atmosphere in the wet hearth melting chamber 140 with an inert atmosphere after loading the solid metal charge 102 into the wet hearth melting chamber 140. The control system 200 may be communicatively coupled to the gas inlet control valve 196, the gas outlet control valve 198, and optionally a vacuum system (not shown). In embodiments, the control system 200 may receive instructions from the user input device to change the atmosphere in the wet hearth melting chamber 140. The machine readable and executable instructions 206, when executed by the processor(s) 202, may cause the control system 200 to automatically receive the instructions to change the atmosphere and operate the gas inlet control valve 196 and the gas outlet control valve 198 to replace the gases in the wet hearth melting chamber 140 with the inert gases from the inert gas source 154. In embodiments, the machine readable and executable instructions 206, when executed by the processor(s) 202, may cause the control system 200 to automatically open the gas outlet control valve 198, evacuate the existing atmosphere from the wet hearth melting chamber 140, then open the gas inlet control valve 196 to introduce the inert gas from the inert gas source 154 into the wet hearth melting chamber 140, run the inert gas through the wet hearth melting chamber 140 for a fixed period of time or until the atmosphere is at least 90%, at least 95%, or even at least 98% inert gas, close the gas outlet control valve 198, and close the gas inlet control valve 196.

In embodiments, the machine readable and executable instructions, when executed by the processor(s) 202, may cause the control system 200 to automatically operate the system 100 in a heating mode, in which the solid metal charge 102 is heated to or maintained at a temperature near the melting point of the metal without melting the solid metal charge 102. For the heating mode, the control system 200 may be communicatively coupled to the pump speed controller 136, the wet hearth level sensor 172, the inlet temperature sensor 174 upstream of the wet hearth melting chamber 140, the outlet temperature sensor 176 downstream of the wet hearth melting chamber 140, or combinations thereof. The control system 200 may also be communicatively coupled to the atmosphere temperature sensor 178 in the wet hearth melting chamber 140. In embodiments, in heating mode, the machine readable and executable instructions 206, when executed by the processor(s) 202, may cause the control system 200 to automatically determine a level of the molten metal 112 in the wet hearth melting chamber 140 and adjust a speed of the pump 130 with the pump speed controller 136 to maintain the level of the molten metal 112 below the bottom of the solid metal charge 102, such as below the top surface of the rails 164, so that the molten metal 112 flowing through the flow channels 166 does not contact the solid metal charge 102. In embodiments, the machine readable and executable instructions 206, when executed by the processor(s) 202, may cause the control system 200 to automatically receive a signal from the wet hearth level sensor 172 indicative of the level of the molten metal 112 in the wet hearth melting chamber 140; compare the measured level of the molten metal 112 to a reference level at which the molten metal 112 would not contact the solid metal charge 102; and when the measured level is greater than the reference level, send a pump control signal to the pump speed controller 136, where the pump control signal causes the pump speed controller 136 to reduce the speed of the pump 130.

In embodiments, the machine readable and executable instructions 206, when executed by the processor(s) 202, may cause the control system 200 to automatically receive an instruction from the user input device to transition from the melting mode to the heating mode, and then transition the wet hearth melting chamber 140 from the melting mode to the heating mode, such as by determining the level of the molten metal 112 in the wet hearth melting chamber 140 and reducing the speed of the pump 130 with the pump speed controller 136 to reduce the level of the molten metal 112 below the bottom of the solid metal charge 102, such as below the top surface of the rails 164, so that the molten metal 112 flowing through the flow channels 166 does not contact the solid metal charge 102. Again, the control system 200 may also operate the supplemental heating unit 180, the gate valve 190, or both in conjunction with the speed of the pump 130 to adjust the level of the molten metal 112 in the wet hearth melting chamber 140.

In embodiments, the control system 200 may be configured to detect when the heating chamber 110 is full of molten metal 112 and automatically transition operation of the wet hearth melting chamber 140 from melting mode to heating mode. The control system 200 may be communicatively coupled to the heating chamber level sensor 122, the pump speed controller 136, and the wet hearth level sensor 172. The control system 200 may also be communicatively coupled to the inlet temperature sensor 174 upstream of the wet hearth melting chamber 140, the outlet temperature sensor 176 downstream of the wet hearth melting chamber 140, the atmosphere temperature sensor 178 in the wet hearth melting chamber 140, the supplemental heating unit 180, the gate valve 190, or combinations thereof. The machine readable and executable instructions 206, when executed by the processor(s) 202, may cause the control system 200 to automatically determine a level of the molten metal 112 in the heating chamber 110; determine whether the level of the molten metal 112 is greater than or equal to a full level; when the level of molten metal 112 in the heating chamber 110 is greater than or equal to the full level, then transition the wet hearth melting chamber 140 from the melting mode to the heating mode, such as by reducing the pump speed of the pump 130 alone or in combination with operating the supplemental heating unit 180, the gate valve 190, or both.

Although not necessary in all instances, in some situations, the wet hearth melting chamber 140 may be operated in the heating mode to preheat the solid metal charge 102 after initial loading and before starting to melt the solid metal charge 102. In embodiments, the machine readable and executable instructions 206, when executed by the processor(s) 202, may cause the control system 200 to automatically operate the system 100 in a preheating mode, in which the solid metal charge 102 is heated from ambient temperature to a temperature near the melting point without melting the solid metal charge 102. The preheating may be conducted after replacing the atmosphere with the inert atmosphere and before commencing melting the solid metal charge 102. For the preheating mode, the control system 200 may be communicatively coupled to the pump speed controller 136, the wet hearth level sensor 172, the inlet temperature sensor 174 upstream of the wet hearth melting chamber 140, and the outlet temperature sensor 176 downstream of the wet hearth melting chamber 140. The machine readable and executable instructions, when executed by the processor(s) 202, may cause the control system 200 to automatically receive an instruction from the user interface to operate in preheat mode; determine the level of the molten metal 112 in the wet hearth melting chamber 140; and maintain the level of the molten metal 112 at a level at which the molten metal 112 does not contact the solid metal charge 102, such as by controlling the speed of the pump 130 with the pump speed controller 136. The machine readable and executable instructions, when executed by the processor(s) 202, may cause the control system 200 to automatically detect when the preheating is complete and the solid metal charge 102 is near the melting temperature. In embodiments, the control system 200 may include a timer, and the machine readable and executable instructions 206, when executed by the processor(s), may cause the control system 200 to automatically operate the wet hearth melting chamber 140 in the preheating mode for a set duration of time using the timer, and at the end of the timer, switch the mode of operation from the preheating or heating mode to the melting mode.

Referring again to FIG. 1, the control system 200 may be configured to operate the system 100 in the melting mode. In embodiments, the machine readable and executable instructions, when executed by the processor(s) 202, may cause the control system 200 to automatically operate the system 100 in the melting mode, during which the solid metal charge 102 is melted by contacting a portion of the solid metal charge 102 with the molten metal 112 flowing through the flow channels 166. For the melting mode, the control system 200 may be communicatively coupled to the pump speed controller 136 and the wet hearth level sensor 172. The control system 200 may also be communicatively coupled to the inlet temperature sensor 174, the outlet temperature sensor 176, the atmosphere temperature sensor 178, the supplemental heating unit 180, the gate valve 190, or combinations thereof. In melting mode, the machine readable and executable instructions 206, when executed by the processor(s) 202, may cause the control system 200 to automatically determine a level of the molten metal 112 in the wet hearth melting chamber 140 and adjust a speed of the pump 130 with the pump speed controller 136 to maintain the level of the molten metal 112 above the bottom of the solid metal charge 102, so that the molten metal 112 flowing through the flow channels 166 contacts the solid metal charge 102. In embodiments, the machine readable and executable instructions 206, when executed by the processor(s) 202, may cause the control system 200 to automatically receive a signal from the wet hearth level sensor 172 indicative of the level of the molten metal 112 in the wet hearth melting chamber 140; compare the measured level of the molten metal 112 to a reference level at which the molten metal 112 contacts the solid metal charge 102; and when the measured level is less than the reference level, send a pump control signal to the pump speed controller 136, where the pump control signal causes the pump speed controller 136 to increase the speed of the pump 130 to raise the level of the molten metal 112 in the wet hearth melting chamber 140.

As previously discussed, the machine readable and executable instructions 206, when executed by the processor(s) 202, may also cause the control system 200 to automatically send control signals to the gate valve 190, the supplemental heating unit 180, or both to operate the gate valve 190 and/or the supplemental heating unit 180, individually or in combination with the pump speed of the pump 130, to control the level of the molten metal 112 in the wet hearth melting chamber 140.

The control system 200 may be configured to increase or decrease the melting rate of the solid metal charge 102 by increasing or decreasing, respectively, the level of the molten metal 112 in the wet hearth melting chamber 140. In embodiments, the machine readable and executable instructions 206, when executed by the processor(s) 202, may also cause the control system 200 to automatically receive instructions from the user interface to increase the melting rate of the solid metal charge 102, determine the level of the molten metal 112 in the wet hearth melting chamber 140, send a control signal to the pump speed controller 136 indicative of an increase in the speed of the pump 130. The machine readable and executable instructions 206, when executed by the processor(s) 202, may also cause the control system 200 to automatically receive instructions from the user interface to decrease the melting rate of the solid metal charge 102, determine the level of the molten metal 112 in the wet hearth melting chamber 140, send a control signal to the pump speed controller 136 indicative of a decrease in the speed of the pump 130. The control signal to the pump speed controller 136 may be determined from process dynamics and from a magnitude of the desired increase or decrease in the melting rate.

In embodiments, the control system 200 may be configured to automatically adjust the melting rate of the solid metal charge 102 based on the level of the molten metal 112 in the heating chamber 110 or the change in level of the molten metal 112 in the heating chamber 110, which is proportional to the rate of consumption of the molten metal by the downstream forming processes. The control system 200 may be communicatively coupled to the heating chamber level sensor 122 in addition to the pump speed controller 136, the wet hearth level sensor 172 and other sensors or control devices. The machine readable and executable instructions 206, when executed by the processor(s) 202, may cause the control system 200 to automatically determine a level of the molten metal 112 in the heating chamber 110 and adjust a speed of the pump 130 with the pump speed controller 136 based on the level of molten metal 112 in the heating chamber 110. The lower the level of molten metal 112 in the heating chamber 110, the greater the melting rate in the wet hearth melting chamber 140. As previously discussed, the control system 200 may be configured to detect when the heating chamber 110 is full of molten metal 112 and automatically transition operation of the wet hearth melting chamber 140 from melting mode to heating mode.

In embodiments, the control system 200 may be configured to change the heat input to the wet hearth melting chamber 140 based on the temperature differential across the wet hearth melting chamber 140. When the temperature differential across the wet hearth melting chamber 140 is too great, the control system 200 may increase the heat delivered to the wet hearth melting chamber 140 by increasing a temperature of the molten metal 112 with the supplemental heating unit 180, increasing a flow rate of the molten metal 112 through the wet hearth melting chamber 140, or both. Increasing the heat to the wet hearth melting chamber 140 by increasing the flow rate of the molten metal 112 may be accomplished by increasing the pump speed of the pump 130 and changing a position of the gate valve 190 to maintain the level of the molten metal 112 in the wet hearth melting chamber 140 constant. Increasing the heat delivered to the wet hearth melting chamber 140 by increasing a temperature of the molten metal 112 with supplemental heating unit 180 may also include adjusting the speed of the pump 130, the position of the gate valve 190, or both to maintaining the same level of the molten metal 112 in the wet hearth melting chamber 140.

When the temperature differential across the wet hearth melting chamber 140 is too small, the molten metal 112 may be returning to the heating chamber 100 at a temperature that is too hot. Additionally, a temperature differential across the wet hearth melting chamber 140 that is too small may also indicate that the wet hearth melting chamber 140 is too hot, which may lead to uncontrollable melting of the solid metal charge 102. The heat delivered to the wet hearth melting chamber 140 may be decreased by reducing any supplemental heat supplied by the supplemental heating unit 180 (if operating), decreasing the flow rate of the molten metal 112 through the wet hearth melting chamber 140, or both. In either case, the pump speed of the pump 130, the position of the gate valve 190, or both may be adjusted to maintain the same level of the molten metal 112 in the wet hearth melting chamber 140 while decreasing the heat input into the wet hearth melting chamber 140.

The control system 200 may be communicatively coupled to the pump speed controller 136, the wet hearth level sensor 172, the inlet temperature sensor 174, the outlet temperature sensor 176, the atmosphere temperature sensor 178, the supplemental heating unit 180, and the gate valve 190. The machine readable and executable instructions 206, when executed by the processor(s), may cause the control system 200 to automatically measure the inlet temperature of the molten metal 112 with the inlet temperature sensor 174, measure the outlet temperature of the molten metal 112 with the outlet temperature sensor 176, determine the temperature differential across the wet hearth melting chamber 140 from the inlet temperature and the outlet temperature, and determine whether to increase or decrease the heat introduced to the wet hearth melting chamber 140 by the molten metal 112 based on the temperature differential. The machine readable and executable instructions 206, when executed by the processor(s), further may cause the control system 200 to automatically determine that the temperature differential is too great and increase the heat delivered to the wet hearth melting chamber 140 by the molten metal 112. The heat delivered to the wet hearth melting chamber 140 may be increased by increasing the temperature of the molten metal 112 with the supplemental heating unit 180, increasing the flow rate of the molten metal 112 through the wet hearth melting chamber 140, or both, as previously discussed herein. The machine readable and executable instructions 206, when executed by the processor(s), further may cause the control system 200 to automatically determine that the temperature differential is too small and decrease the heat delivered to the wet hearth melting chamber 140 by the molten metal 112. The heat delivered to the wet hearth melting chamber 140 by the molten metal 112 may be decreased by decreasing heat added to the molten metal 112 by the supplemental heating unit 180 (if operating), reducing the flow rate of molten metal 112 through the wet hearth melting chamber 140, or both, as previously discussed herein.

Referring again to FIG. 1, whether in heating mode or melting mode, the control system 200 may be configured to adjust the speed of the pump 130 based on the inlet temperature of the molten metal 112 at the wet hearth inlet 144. The temperature of the molten metal 112 can influence the viscosity of the molten metal 112, which impacts the flow rate of the molten metal 112 through the wet hearth melting chamber 140 and the liquid level of the molten metal 112 in the wet hearth melting chamber 140. For a given liquid level in the wet hearth melting chamber 140, a greater temperature of the molten metal 112 requires a greater pump speed of the pump 130 to maintain the given liquid level, provided the gate valve 190 is maintained in the same position. The constant liquid level can also be maintained by adjusting the position of the gate valve 190 while maintaining the pump speed of the pump 130 constant, or by adjusting both the pump speed of the pump 130 and the position of the gate valve 190. In embodiments, the machine readable and executable instructions 206, when executed by the processor(s) 202, may cause the control system 200 to automatically measure the inlet temperature of the molten metal 112 with the inlet temperature sensor 174 and adjust a speed of the pump 130, a position of the gate valve 190, or both, based on the inlet temperature of the molten metal 112 to maintain a constant liquid level in the wet hearth melting chamber 140.

In some instances, the inlet temperature of the molten metal 112 or outlet temperature of the molten metal 112 may be too low, which may reduce the heat transfer to the solid metal charge 102 and may present the risk of the molten metal solidifying in the wet hearth melting chamber 140. The supplemental heating unit 180 may be operated to increase the temperature of the molten metal 112 upstream of the wet hearth melting chamber 140. In embodiments, the machine readable and executable instructions 206, when executed by the processor(s) 202, may cause the control system 200 to automatically measure the inlet temperature of the molten metal 112 with the inlet temperature sensor 174 and adjust a temperature of the molten metal 112 with the supplemental heating unit 180 in response to the inlet temperature of the molten metal 112. The control system 200 may increase or decrease the heat added to the molten metal 112 by the supplemental heating unit 180, such as by controlling the output of the heating elements of the supplemental heating unit 180.

In some other instances, in melting mode, the viscosity of the molten metal 112 may be too low, which may cause the molten metal 112 to flow through the flow channels 166 and into the outlet channel 170 too quickly without contacting the solid metal charge 102. Thus, in embodiments, the control system 200 may be communicatively coupled to the gate valve 190 and may be configured to adjust a position of the gate valve 190 to increase or decrease resistance to flow of the molten metal 112 through the wet hearth outlet 146. At least partially closing the gate valve 190 may reduce the cross-sectional area of the wet hearth outlet 146, which may create back pressure that reduces the flow rate of the molten metal 112 through the wet hearth melting chamber 140, enabling better control of the liquid level when the viscosity of the molten metal 112 is low.

In embodiments, the control system 200 may be configured to disallow pumping of the molten metal 112 into the wet hearth melting chamber 140 if the temperature of the wet hearth melting chamber 140 is outside of prescribed limits. The control system 200 may be communicatively coupled to the atmosphere temperature sensor 178 in the wet hearth melting chamber 140 and the pump speed controller 136. The machine readable and executable instructions 206, when executed by the processor(s) 202, may cause the control system 200 to automatically: determine a temperature of the wet hearth melting chamber 140 with the atmosphere temperature sensor 178; if the temperature of the wet hearth melting chamber 140 is less than a low temperature set-point or greater than a high temperature set-point, disallow operation of the pump 130, where the low temperature set-point is a temperature below which the risk of the molten metal 112 solidifying in the wet hearth melting chamber 140 is high, and the high temperature set-point is a temperature above which the solid metal charge 102 is likely to melt uncontrollably; and if the temperature of the wet hearth melting chamber 140 is greater than the low temperature set-point and less than the high temperature set-point, allow operation of the pump 130 to pump the molten metal 112 into the wet hearth melting chamber 140.

In embodiments, the control system 200 may be configured to change the flow rate of the molten metal 112 through the wet hearth melting chamber 140 at constant level of the molten metal 112 based on the temperature in the wet hearth melting chamber 140. In embodiments, the machine readable and executable instructions 206, when executed by the processor(s) 202, may cause the control system 200 to automatically: determine a temperature of the wet hearth melting chamber 140 using the atmosphere temperature sensor 178; determine that the temperature of the wet hearth melting chamber 140 is too high or too low; and adjust a flow rate of the molten metal 112 through the wet hearth melting chamber 140 while maintaining the level of the molten metal 112 in the wet hearth melting chamber 140. Adjusting the flow rate of the molten metal 112 through the wet hearth melting chamber 140 while maintaining the level of the molten metal 112 in the wet hearth melting chamber 140 may include changing the pump speed of the pump 130 to change the flow rate of the molten metal 112 and changing a position of the gate valve 190 at the wet hearth outlet 146 to maintain the liquid level of the molten metal 112 in the wet hearth melting chamber 140.

Referring again to FIG. 1, in embodiments, the control system 200 may be configured to identify when all of the solid metal charge 102 has been melted and the wet hearth melting chamber 140 is ready for reloading. In embodiments, the control system 200 may be configured to pause operation of the wet hearth melting chamber 140 for reloading with additional solid metal charge 102. The control system 200 may be configured to monitor the temperature differential across the wet hearth melting chamber 140, determine when all of the solid metal charge 102 has been melted from the temperature differential across the wet hearth melting chamber 140, and reduce the level of the molten metal 112 in the wet hearth melting chamber 140 to prepare for reloading. The determination of whether all of the solid metal charge 102 has been melted can be based on the temperature differential across the wet hearth melting chamber 140. In embodiments, the machine readable and executable instructions 206, when executed by the processor(s) 202, may cause the control system 200 to automatically monitor the temperature differential across the wet hearth melting chamber 140 using the inlet temperature sensor 174 and the outlet temperature sensor 176, determine when the temperature differential across the wet hearth melting chamber 140 indicates that all the solid metal charge 102 has been melted, and then reducing the liquid level of the molten metal 112 in the wet hearth melting chamber 140 to below the top surface of the rails 164 by reducing the speed of the pump 130.

Since melting the metals requires heat transfer, which reduces the temperature of the molten metal 112, when all of the metal is melted, the heat transfer requirement is reduced. This results in an increase in the outlet temperature of the molten metal 112 and a resulting decrease in the temperature differential across the wet hearth melting chamber 140. The temperature differential across the wet hearth melting chamber 140 may gradually decrease toward the end of melting and then may plateau at or near a temperature differential of 0 (zero) ° C. once all the metal has been melted.

In embodiments, the control system 200 may be configured to monitor the level of the molten metal 112 in the heating chamber 110, and determine when all of the solid metal charge 102 in the wet hearth melting chamber 140 has been melted and the wet hearth melting chamber 140 is ready for reloading from the level of the molten metal 112 in the heating chamber 110. Melting the solid metal charge 102 may increase the level of the molten metal 112 in the heating chamber 110. Thus, the point at which the level of the molten metal 112 in the heating chamber 110 stops increasing, or even begins to decrease, may indicate that the solid metal charge 102 in the wet hearth melting chamber 140 has been completely melted.

In embodiments, the control system 200, through execution of the machine readable and executable instructions 206, may also produce an alert signal, which may be used to alert the operator, such as through a visual or audio signal, of the need to reload the wet hearth melting chamber 140. In embodiments, the machine readable and executable instructions 206, when executed by the processor(s) 202, may cause the control system 200 to automatically monitor the temperature differential across the wet hearth melting chamber 140 using the inlet temperature sensor 174 and the outlet temperature sensor 176, monitor the level of the molten metal 112 in the heating chamber 110 with the heating chamber level sensor 122, or both; determine when the temperature differential across the wet hearth melting chamber 140 and/or the level of molten metal 112 in the heating chamber 110 indicates that all the solid metal charge 102 has been melted; and then output an alert signal indicating that the wet hearth melting chamber 140 is empty and reloading is recommended. In embodiments, the control system 200 may be configured to outlet a level alarm when the level of the molten metal 112 in the heating chamber 110 is either too high or too low. In embodiments, the control system 200, through execution of the machine readable and executable instructions 206 by the processor(s) 202, may be configured to monitor the level of molten metal 112 in the heating chamber 110 with the heating chamber level sensor 122, determine when the level of molten metal 112 is below a low level threshold, and output a low level alarm indicative of a need to reload the wet hearth melting chamber 140 with additional solid metal charge 102. In embodiments, the control system 200, through execution of the machine readable and executable instructions 206 by the processor(s) 202, may be configured to monitor the level of molten metal 112 in the heating chamber 110 with the heating chamber level sensor 122, determine when the level of molten metal 112 is below a critically low level threshold, and output a critically low level alarm, which may be indicative of the level of molten metal 112 being below the minimum level required to operate the downstream forming process.

Embodiments of the disclosure may be embodied in hardware and/or in software (including firmware, resident software, micro-code, etc.). The control system 200 may include the at least one processor 202 and the at least one memory module 204, as previously described in this specification. The control system 200 may be communicatively coupled to one or more system components (e.g., heating elements 118 in the heating chamber 110, the heating chamber temperature sensor 120, the heating chamber level sensor 122, the pump speed controller 136, the wet hearth level sensor 172, the inlet temperature sensor 174 upstream of the wet hearth melting chamber 140, the outlet temperature sensor 176 downstream of the wet hearth melting chamber 140, the atmosphere temperature sensor 178 in the wet hearth melting chamber 140, the supplemental heating unit 180, the gate valve 190, the gas inlet control valve 196, the gas outlet control valve 198, or any other control device described herein) via any wired or wireless communication pathway, including execution of control and/or communication between the control system and the equipment through the cloud. A computer-usable or the machine-readable storage medium, such as the one or more memory modules 204, may be any medium that can contain, store, communicate, propagate, or transport the program for use by or in connection with the instruction execution system, apparatus, or device.

The computer-usable or machine-readable storage medium, such as memory module 204, may be, for example but not limited to, an electronic, magnetic, optical, electromagnetic, infrared, or semiconductor system, apparatus, device, or propagation medium. More specific examples (a non-exhaustive list) of the memory module(s) 204 would include but are not limited to the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CD-ROM), or any other existing or future developed medium for storing electronic data. Note that the computer-usable or machine-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The machine-readable storage medium or memory module(s) 204 may include the machine readable and executable instructions 206 for carrying out operations of the present disclosure. The machine readable and executable instructions 206 may include computer program code that may be written in a high-level programming language, such as but not limited to C or C++, for development convenience. In addition, computer program code for carrying out operations of the present disclosure may also be written in other programming languages, such as, but not limited to, interpreted languages. It is not intended to limit the scope of the disclosure to any particular programming language. Some modules or routines may be written in assembly language or even micro-code to enhance performance and/or memory usage. However, software embodiments of the present disclosure do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

In embodiments, the control system 200 disclosed herein may be located at the equipment in question, such as at or on the system 100, or any subsystem or component thereof, and may be communicatively coupled to the equipment through wired or wireless communication. In embodiments, the control system 200 disclosed herein may be located in a remote location or may be a part of the cloud, and control of the system 100, or any subsystem or component thereof, may be conducted by communication through the cloud, wireless network, wired network, LAN, or any other suitable communication method or network type.

Referring again to FIG. 1, a method of melting a solid metal charge 102 in the systems 100 disclosed herein may include placing the solid metal charge 102 on the rails 164 in the wet hearth melting chamber 140, introducing an inert atmosphere into the wet hearth melting chamber 140, and generating a flow of the molten metal 112 from the heating chamber 110 to the wet hearth melting chamber 140, wherein the molten metal 112 flows through the flow channels 166 defined between the rails 164 and heat transfers from the molten metal 112 to the solid metal charge 102 supported on the rails 164. The methods may further include increasing the flow rate of the molten metal 112 until the level of the molten metal 112 in the wet hearth melting chamber 140 increases and submerges at least a portion of the solid metal charge 102, where submersion of the at least a portion of the solid metal charge 102 causes the solid metal charge 102 to melt.

The solid metal charge 102 may be a prime metal source, scrap metal, or a combination of both. In embodiments, the solid metal charge 102 may be a prime metal charge. In embodiments, the solid metal charge 102 may be in the form of sow, ingots, T-bars, or combinations of these. In embodiments, the solid metal charge 102 may comprise aluminum, magnesium, alloys thereof, or any combinations thereof. In embodiments, the solid metal charge 102 may be in the form of scrap metal. In embodiments, the solid metal charge 102 is not preheated before melting in the wet hearth melting chamber 140.

Introducing the inert atmosphere into the wet hearth melting chamber 140 may include sealing the wet hearth melting chamber 140, evacuating the wet hearth melting chamber 140, and after evacuating the wet hearth melting chamber 140, flooding the wet hearth melting chamber 140 with an inert gas. The inert atmosphere may comprise greater than or equal to 90%, greater than or equal to 95%, or greater than or equal to 98%, or greater than or equal to 99% by mole of an inert gas. The inert gas of the inert atmosphere may be selected from the consisting of nitrogen, helium, neon, argon, krypton, xenon, and any combinations thereof.

In embodiments, the methods may include preheating the solid metal charge 102. Preheating the solid metal charge 102 may comprise adjusting the level of the molten metal 112 in the wet hearth melting chamber 140 to a preheat level just below a bottom surface of the solid metal charge 102 when supported on the rails 164, and circulating the molten metal 112 through wet hearth melting chamber 140 at the preheat level for a period of time sufficient to preheat the solid metal charge 102.

In embodiments, the methods disclosed herein may include changing the melting rate of the solid metal charge 102 in the wet hearth melting chamber 140. Changing the melting rate of the solid metal charge 102 may include changing a speed of the pump 130 to raise or lower the liquid level of the molten metal 112 in the wet hearth melting chamber 140. As previously discussed, increasing the liquid level increases the melting rate by submerging a greater portion of the solid metal charge 102 in the molten metal 112. Likewise, decreasing the liquid level of the molten metal 112 in the wet hearth melting chamber 140 decreases the melting rate. The method may further include measuring a level of the molten metal 112 in the heating chamber 110, and changing the melting rate of the solid metal charge 102 in the wet hearth melting chamber 140 based on the level of the molten metal 112 in the heating chamber 110. The methods may further include determining that the heating chamber 110 is full based on the measuring the level of the molten metal 112 in the heating chamber 110, and reducing a level of the molten metal 112 in the wet hearth melting chamber 140 below a bottom surface of the solid metal charge 102, wherein reducing the level of the molten metal 112 takes the molten metal 112 out of contact with the solid metal charge 102 and ceases melting of the solid metal charge 102. In embodiments, the methods do not include preheating the solid metal charge. The methods may include any other operations previously described herein with respect to operation of the control system 200.

The systems 100 and method disclosed herein may be used to melt metals to produce molten metal for use in downstream metal forming processes for making various articles or parts. the downstream forming processes may include a casting process, a liquid forging process, or other forming processes utilizing a molten metal. The systems and methods may be used with any suitable type of metal. Examples include but are not limited to aluminum, magnesium, and any alloys or combinations thereof. Other metals and metal alloys are contemplated.

A first aspect disclosed herein is directed to a system for melting metals that may include a heating chamber configured to contain a molten metal, and a wet hearth melting chamber. The heating chamber may comprise a heating chamber inlet, a heating chamber outlet, and one or more heating elements configured to add heat to the molten metal contained within the heating chamber. The wet hearth melting chamber may comprise a wet hearth inlet in fluid communication with the heating chamber outlet through an inlet flow path; a wet hearth outlet in fluid communication with the heating chamber inlet through an outlet flow path; a refractory shelf having a top surface positioned vertically above the wet hearth inlet and the wet hearth outlet and a plurality of rails disposed on top of the top surface and spaced apart from one another to form a plurality of flow channels therebetween. The wet hearth melting chamber may define an inlet channel fluidly coupling the wet hearth inlet to the top surface of the refractory shelf and an outlet channel fluidly coupling the top surface of the refractory shelf to the wet hearth outlet. The system may comprise a pump disposed in the inlet flow path between the heating chamber outlet and the wet hearth inlet, where the pump may be configured to produce a flow of the molten metal from the heating chamber to the wet hearth melting chamber through the inlet flow path.

A second aspect disclosed herein may include the first aspect, wherein the pump is a variable speed pump.

A third aspect disclosed herein may include either one of the first or second aspects, further comprising a pump speed controller operatively coupled to the pump and configured to change a pumping rate of the pump.

A fourth aspect disclosed herein may include any one of the first through third aspects, wherein the wet hearth melting chamber may comprise a top opening and a loading hatch moveable between an open position and a closed position, wherein: in the open position, the loading hatch may expose the top opening to allow loading of a solid metal charge into the wet hearth melting chamber; and in the closed position, the loading hatch may seal against an outer wall of the wet hearth melting chamber to close off the top opening.

A fifth aspect disclosed herein may include any one of the first through fourth aspects, further comprising an inert gas source, wherein the wet hearth melting chamber may comprise a gas inlet and a gas outlet, wherein the gas inlet is fluidly coupled to the inert gas source.

A sixth aspect disclosed herein may include any one of the first through fifth aspects, wherein the wet hearth outlet may be offset from the wet hearth inlet.

A seventh aspect disclosed herein may include any one of the first through sixth aspects, wherein the wet hearth outlet may be offset from the wet hearth inlet in a horizontal direction, a vertical direction, or both.

An eighth aspect disclosed herein may include any one of the first through seventh aspects, wherein the wet hearth melting chamber may comprise a wet hearth level sensor configured to measure a level of molten metal in the wet hearth melting chamber.

A ninth aspect disclosed herein may include the eighth aspect, wherein the wet hearth level sensor may be a laser level sensor, a radar level sensor, a contact probe level sensor, or combinations thereof.

A tenth aspect disclosed herein may include any one of the first through ninth aspects, further comprising an inlet temperature sensor and an outlet temperature sensor, wherein: the inlet temperature sensor may be disposed in the inlet molten metal flow path between the heating chamber and the wet hearth melting chamber and may be configured to measure an inlet temperature of the molten metal upstream of the wet hearth melting chamber; and the outlet temperature sensor may be disposed in the outlet molten metal flow path between the wet hearth melting chamber and the heating chamber and may be configured to measure an outlet temperature of the molten metal downstream of the wet hearth melting chamber.

An eleventh aspect disclosed herein may include any one of the first through tenth aspects, wherein the wet hearth melting chamber further may comprise an atmosphere temperature sensor configured to measure a temperature of the atmosphere in the wet hearth melting chamber.

A twelfth aspect disclosed herein may include any one of the first through eleventh aspects, wherein the one or more heating elements may comprise electric heating elements, gas fired burners, or any combinations thereof.

A thirteenth aspect disclosed herein may include any one of the first through twelfth aspects, wherein the one or more heating elements may comprise reverberatory heating elements, immersion heating elements, or any combination thereof.

A fourteenth aspect disclosed herein may include any one of the first through thirteenth aspects, wherein the heating chamber may comprise a heating chamber level sensor configured to measure a level of molten metal in the heating chamber.

A fifteenth aspect disclosed herein may include the fourteenth aspect, wherein the heating chamber level sensor may be a laser level sensor, a radar level sensor, a contact probe level sensor, or any combination thereof.

A sixteenth aspect disclosed herein may include any one of the first through fifteenth aspects, wherein the heating chamber may comprise at least one heating chamber temperature sensor configured to measure a temperature of a molten metal contained within the heating chamber.

A seventeenth aspect disclosed herein may include any one of the first through sixteenth aspects, further comprising a supplemental heating unit configured to further heat the molten metal upstream or downstream of the wet hearth melting chamber.

An eighteenth aspect disclosed herein may include the seventeenth aspect, wherein the supplemental heating unit may be disposed in the inlet molten metal flow path upstream of the wet hearth melting chamber.

A nineteenth aspect disclosed herein may include either one of the seventeenth or eighteenth aspects, wherein the supplemental heating unit may comprise one or more heating elements.

A twentieth aspect disclosed herein may include any one of the first through nineteenth aspects, further comprising a gate valve disposed in the outlet molten metal flow path proximate to the wet hearth outlet, wherein the gate valve may be configured to control a flow rate of the molten metal flowing out of the wet hearth melting chamber back to the heating chamber.

A twenty-first aspect disclosed herein may include any one of the first through twentieth aspects, further comprising a control system comprising at least one processor, at least one memory module, and computer readable and executable instructions stored on the at least one memory module.

A twenty-second aspect disclosed herein may include the twenty-first aspect, wherein the control system may be communicatively coupled to the one or more heating elements, a heating chamber temperature sensor, a heating chamber level sensor, a pump speed controller, a wet hearth level sensor, an inlet temperature sensor, an outlet temperature sensor, a wet hearth atmosphere temperature sensor, a supplemental heating unit, a gate valve, a gas inlet control valve, a gas outlet control valve, or any combinations thereof.

A twenty-third aspect disclosed herein may include the twenty-second aspect, wherein the computer readable and executable instructions, when executed by the processor(s), may cause the control system to automatically replace an atmosphere in the wet hearth melting chamber with an inert atmosphere after loading a solid metal charge into the wet hearth melting chamber.

A twenty-fourth aspect disclosed herein may include either one of the twenty-second or twenty-third aspects, wherein the computer readable and executable instructions, when executed by the processor(s), may cause the control system to automatically operate the system in a heating mode, in which a solid metal charge is heated to or maintained at a temperature near the melting point of the solid metal charge without melting the solid metal charge.

A twenty-fifth aspect disclosed herein may include the twenty-fourth aspect, wherein the computer readable and executable instructions, when executed by the processor(s), may cause the control system to automatically determine a level of a molten metal in the wet hearth melting chamber and adjust a speed of the pump with the pump speed controller to maintain the level of the molten metal below a bottom of the solid metal charge so that the molten metal flowing through the flow channels does not contact the solid metal charge.

A twenty-sixth aspect disclosed herein may include any one of the twenty-second through twenty-fifth aspects, wherein machine readable and executable instructions, when executed by the processor(s), may cause the control system to automatically determine a level of a molten metal in the heating chamber; determine whether the level of the molten metal is greater than or equal to a full level; and when the level of molten metal in the heating chamber is greater than or equal to the full level, transition the wet hearth melting chamber from a melting mode to a heating mode.

A twenty-seventh aspect disclosed herein may include any one of the twenty-second through twenty-sixth aspects, wherein the machine readable and executable instructions, when executed by the processor(s), may cause the control system to automatically operate the system in a preheating mode, in which a solid metal charge is heated from ambient temperature to a temperature near a melting point of the solid metal charge without melting the solid metal charge.

A twenty-eighth aspect disclosed herein may include the twenty-seventh aspect, wherein the machine readable and executable instructions, when executed by the processor(s), may cause the control system to automatically: determine an inlet temperature of a molten metal with the inlet temperature sensor, determine an outlet temperature of the molten metal with the outlet temperature sensor, calculate a temperature differential across the wet hearth melting chamber from the inlet temperature and the outlet temperature, and determine that preheating of the solid metal charge is complete based on the temperature differential across the wet hearth melting chamber.

A twenty-ninth aspect disclosed herein may include any one of the twenty-second through twenty-eighth aspects, wherein the machine readable and executable instructions, when executed by the processor(s), may cause the control system to automatically operate the system in a melting mode, during which a solid metal charge is melted by contacting a portion of the solid metal charge with a molten metal flowing through the flow channels defined between the rails attached to the refractory shelf.

A thirtieth aspect disclosed herein may include the twenty-ninth aspect, wherein the machine readable and executable instructions, when executed by the processor(s), may cause the control system to automatically receive instructions to change a melting rate of the solid metal charge, determine the level of the molten metal in the wet hearth melting chamber, and send a control signal to the pump speed controller indicative of an change in the speed of the pump.

A thirty-first aspect disclosed herein may include either one of the twenty-ninth or thirtieth aspects, wherein the machine readable and executable instructions, when executed by the processor(s), may cause the control system to automatically determine a level of the molten metal in the heating chamber; and adjust a speed of the pump with the pump speed controller based on the level of the molten metal in the heating chamber.

While various embodiments of the present subject matter have been described herein, it should be understood that it is contemplated that each of these embodiments and techniques may be used separately or in conjunction with one or more embodiments and techniques. It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A system for melting metals, the system comprising:
a heating chamber configured to contain a molten metal, the heating chamber comprising a heating chamber inlet, a heating chamber outlet, and one or more heating elements configured to add heat to the molten metal contained within the heating chamber;
a wet hearth melting chamber comprising:
a wet hearth inlet in fluid communication with the heating chamber outlet through an inlet flow path;
a wet hearth outlet in fluid communication with the heating chamber inlet through an outlet flow path;
a refractory shelf having a top surface positioned vertically above the wet hearth inlet and the wet hearth outlet and a plurality of rails disposed on top of the top surface and spaced apart from one another to form a plurality of flow channels therebetween, wherein the wet hearth melting chamber defines an inlet channel fluidly coupling the wet hearth inlet to the top surface of the refractory shelf and an outlet channel fluidly coupling the top surface of the refractory shelf to the wet hearth outlet; and
a pump disposed in the inlet flow path between the heating chamber outlet and the wet hearth inlet, the pump configured to produce a flow of the molten metal from the heating chamber to the wet hearth melting chamber through the inlet flow path.

2. The system of claim 1, wherein the pump is a variable speed pump and the system comprises a pump speed controller operatively coupled to the pump and configured to change a pumping rate of the pump.

3. The system of claim 1, further comprising an inert gas source, wherein the wet hearth melting chamber comprises a gas inlet and a gas outlet, wherein the gas inlet is fluidly coupled to the inert gas source.

4. The system of claim 1, wherein the wet hearth outlet is offset from the wet hearth inlet in a horizontal direction, a vertical direction, or both.

5. The system of claim 1, wherein the wet hearth melting chamber comprises a wet hearth level sensor configured to measure a level of molten metal in the wet hearth melting chamber.

6. The system of claim 1, further comprising an inlet temperature sensor and an outlet temperature sensor, wherein:
the inlet temperature sensor is disposed in the inlet molten metal flow path between the heating chamber and the wet hearth melting chamber and is configured to measure an inlet temperature of the molten metal upstream of the wet hearth melting chamber; and
the outlet temperature sensor is disposed in the outlet molten metal flow path between the wet hearth melting chamber and the heating chamber and is configured to measure an outlet temperature of the molten metal downstream of the wet hearth melting chamber.

7. The system of claim 1, wherein the wet hearth melting chamber further comprises an atmosphere temperature sensor configured to measure a temperature of the atmosphere in the wet hearth melting chamber.

8. The system of claim 1, wherein the one or more heating elements comprise electric heating elements, gas fired burners, or any combinations thereof, or the one or more heating elements comprise reverberatory heating elements, immersion heating elements, or any combination thereof.

9. The system of claim 1, wherein the heating chamber comprises a heating chamber level sensor configured to measure a level of molten metal in the heating chamber, wherein the heating chamber level sensor is a laser level sensor, a radar level sensor, a contact probe level sensor, or any combination thereof.

10. The system of claim 1, wherein the heating chamber comprises at least one heating chamber temperature sensor configured to measure a temperature of a molten metal contained within the heating chamber.

11. The system of claim 1, further comprising a supplemental heating unit configured to further heat the molten metal upstream or downstream of the wet hearth melting chamber, wherein the supplemental heating unit is disposed in the inlet molten metal flow path upstream of the wet hearth melting chamber.

12. The system of claim 1, further comprising a gate valve disposed in the outlet molten metal flow path proximate to the wet hearth outlet, wherein the gate valve is configured to control a flow rate of the molten metal flowing out of the wet hearth melting chamber back to the heating chamber.

13. The system of claim 1, further comprising a control system comprising at least one processor, at least one memory module, and computer readable and executable instructions stored on the at least one memory module, wherein the control system is communicatively coupled to the one or more heating elements, a heating chamber temperature sensor, a heating chamber level sensor, a pump speed controller, a wet hearth level sensor, an inlet temperature sensor, an outlet temperature sensor, a wet hearth atmosphere temperature sensor, a supplemental heating unit, a gate valve, a gas inlet control valve, a gas outlet control valve, or any combinations thereof.

14. The system of claim 13, wherein the computer readable and executable instructions, when executed by the processor(s), cause the control system to automatically replace an atmosphere in the wet hearth melting chamber with an inert atmosphere after loading a solid metal charge into the wet hearth melting chamber.

15. The system of claim 13, wherein the computer readable and executable instructions, when executed by the processor(s), cause the control system to automatically operate the system in a heating mode, in which a solid metal charge is heated to or maintained at a temperature near the melting point of the solid metal charge without melting the solid metal charge.

16. The system of claim 15, wherein the computer readable and executable instructions, when executed by the processor(s), cause the control system to automatically determine a level of a molten metal in the wet hearth melting chamber and adjust a speed of the pump with the pump speed controller to maintain the level of the molten metal below a bottom of the solid metal charge so that the molten metal flowing through the flow channels does not contact the solid metal charge.

17. The system of claim 13, wherein machine readable and executable instructions, when executed by the processor(s), cause the control system to automatically determine a level of a molten metal in the heating chamber; determine whether the level of the molten metal is greater than or equal to a full level; and when the level of molten metal in the heating chamber is greater than or equal to the full level, transition the wet hearth melting chamber from a melting mode to a heating mode.

18. The system of claim 13, wherein the machine readable and executable instructions, when executed by the processor(s), cause the control system to automatically operate the system in a melting mode, during which a solid metal charge is melted by contacting a portion of the solid metal charge with a molten metal flowing through the flow channels defined between the rails attached to the refractory shelf.

19. The system of claim 18, wherein the machine readable and executable instructions, when executed by the processor(s), cause the control system to automatically receive instructions to change a melting rate of the solid metal charge, determine the level of the molten metal in the wet hearth melting chamber, and send a control signal to the pump speed controller indicative of an change in the speed of the pump.

20. The system of claim 18, wherein the machine readable and executable instructions, when executed by the processor(s), cause the control system to automatically determine a level of the molten metal in the heating chamber; and adjust a speed of the pump with the pump speed controller based on the level of the molten metal in the heating chamber.
